(19) United States
(12) Patent Application Publication
(10) Pub. No.: US 2018/0128199 A1
(43) Pub. Date: May 10, 2018

(54) PRE-MIXING ENGINE SYSTEM AND CONTROL METHOD FOR THE SAME

(71) Applicants: Hyundai Motor Company, Seoul (KR); Kia Motors Corporation, Seoul (KR)

(72) Inventors: Kyoungchan HAN, Gunpo-si (KR); Joonhee Lee, Incheon (KR)

(73) Assignees: Hyundai Motor Company, Seoul (KR); Kia Motors Corporation, Seoul (KR)

(21) Appl. No.: 15/726,032

(22) Filed: Oct. 5, 2017

(30) Foreign Application Priority Data
Nov. 8, 2016 (KR) 10-2016-0148371

(51) Int. Cl. F02D 41/30; F02D 41/00; F02D 13/02; F02D 41/40

(52) U.S. Cl. CPC F02D 41/3035; F02D 41/008; F02D 13/0226; F02D 2041/389; F02D 2041/001; F02D 2200/0414; F02D 41/40

(57) ABSTRACT

A pre-mixing engine system may include a plurality of cylinders that are combusted in a predetermined sequence; an intake manifold connected to the cylinder; a variable valve apparatus controlling an intake valve closing timing of each cylinder; an injector injecting a fuel inside each cylinder; an operation state measuring device detecting an operation state of an engine to output a corresponding signal; and a controller configured for controlling operations of the injector and the variable valve apparatus depending on the corresponding signal of the operation state measuring device, wherein the controller determines whether the operation state of the current engine is a predetermined general operation mode requirement state or a predetermined pre-mixing mode requirement state and controls the operations of the variable valve apparatus and the injector in the case of the pre-mixing mode requirement state to output a mixture of the corresponding cylinder to the intake manifold.

### CROSS-REFERENCE TO RELATED APPLICATION

The present application claims priority to Korean Patent Application No. 10-2016-0148371 filed on Nov. 8, 2016, the entire contents of which is incorporated herein for all purposes by this reference.

### BACKGROUND OF THE INVENTION

### Field of the Invention

The present invention relates to a pre-mixing engine system and a control method for the same. More particularly, the present invention relates to a pre-mixing engine system flowing backward a fuel in a cylinder to be combusted in other cylinder and a control method for the same.

### Description of Related Art

Nox is generated in a combust process of an internal combustion engine, and a soot is locally generated in a rich region.

To solve this problem, many researches and developments have been conducted, however it is difficult to solve problems that a combustion noise deteriorates due to a rapid combust or a fuel is attached on a wall to cause the soot through methods that the fuel is directly injected to the combustion chamber or is injected to a port.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a pre-mixing engine system and a control method for the same by forming a homogenous mixture to lower a maximum temperature of a combustion period, reducing a nitrogen oxide and a soot generation.

A pre-mixing engine system according to an exemplary embodiment of the present invention includes a plurality of cylinders that are combusted in a predetermined sequence; an intake manifold connected to the cylinder; a variable valve apparatus controlling an intake valve closing timing of each cylinder; an injector injecting a fuel inside each cylinder; an operation state measuring device detecting an operation state of an engine to output a corresponding signal; and a controller configured for controlling operations of the injector and the variable valve apparatus depending on the corresponding signal of the operation state measuring device, wherein the controller determines whether the operation state of the current engine is a predetermined general operation mode requirement state or a predetermined pre-mixing mode requirement state and controls the operations of the variable valve apparatus and the injector in the case of the pre-mixing mode requirement state to output a mixture of the corresponding cylinder to the intake manifold.

The controller may control the operation of the variable valve apparatus to delay the intake valve closing timing and may control the operation of the injector to perform a pre-mixing injection injecting a fuel to be flowed backward thereof.

The operation state measuring device may include an engine speed sensor, an acceleration pedal opening sensor, a cooling coolant temperature sensor, an intake air temperature sensor, an air flow sensor, and a boost pressure sensor.

The controller may determine a pre-mixing fuel amount ratio in the case of the pre-mixing mode requirement state, may determine an air amount to be flowed backward to determine a valve timing depending on the determined backflow air amount, controlling the operation of the variable valve apparatus, and may control the operation of the injector depending on the determined pre-mixing fuel amount ratio.

The controller may determine an entire injection fuel amount, a pre-mixing fuel amount requirement value, and a pre-mixing fuel amount requirement ratio depending on the signal of the operation state measuring device, and may control the operation of the injector depending on the determined pre-mixing fuel amount requirement value at a pre-mixing mode conversion beginning.

The controller may determine a backflow air amount, a backflow air ratio, and a backflow fuel amount depending on the signal of the operation state measuring device, the pre-mixing fuel amount requirement ratio, and a pre-mixing fuel injection amount of the previous combust sequence cylinder after the pre-mixing mode conversion beginning, may determine a reference mixing injection amount depending on the backflow air amount, the backflow air ratio, and the backflow fuel amount, and may determine a correction factor depending on the determined reference mixing injection amount and the pre-mixing fuel injection amount of the previous combust sequence cylinder, and the controller may control the operations of the variable valve apparatus and the injector depending on a sum of the correction factor and the pre-mixing fuel injection amount of the previous combust sequence cylinder.

The controller may determine the correction factor and the pre-mixing fuel injection amount of the previous combust sequence cylinder through a feedback.

The controller may determine a starting timing of the pre-mixing injection depending on a timing that an air in the cylinder is flowed backward to the intake manifold, a time that the fuel is vaporized in the cylinder, and an injection period of the pre-mixing fuel to control the operation of the injector.

The controller may determine a finishing timing of the pre-mixing injection before a closing time of the intake valve to control the operation of the injector.

A control method of a pre-mixing engine system including a plurality of cylinders that are combusted in a predetermined sequence; an intake manifold connected to the cylinder; a variable valve apparatus controlling an intake valve closing timing of each cylinder; an injector injecting a fuel inside each cylinder; an operation state measuring device detecting an operation state of an engine to output a corresponding signal; and a controller configured for controlling operations of the injector and the variable valve apparatus depending on the corresponding signal of the operation state measuring device according to an exemplary embodiment of the present invention includes determining whether an operation state of a current engine is a predetermined general operation mode requirement state or a predetermined pre-mixing mode requirement state through the controller; determining a pre-mixing fuel amount ratio in the case of the pre-mixing mode requirement state through the controller; determining an air amount to be flowed backward and a valve timing depending on the determined backflow air amount to control the operation of the variable valve apparatus through the controller; and controlling the operation of the injector depending on the determined pre-mixing fuel amount ratio through the controller.

The controller may determine an entire injection fuel amount, a pre-mixing fuel amount requirement value, and a pre-mixing fuel amount requirement ratio depending on a signal of the operation state measuring device, and the controller may control the operation of the injector depending on the determined pre-mixing fuel amount requirement value at a pre-mixing mode conversion beginning.

The controller may determine a backflow air amount, a backflow air ratio, and a backflow fuel amount depending on the signal of the operation state measuring device, a pre-mixing fuel amount requirement ratio, and a pre-mixing fuel injection amount of the previous combust sequence cylinder after the pre-mixing mode conversion beginning, the controller may determine a reference mixing injection amount depending on the backflow air amount, the backflow air ratio, and the backflow fuel amount, the controller may determine a correction factor depending on the determined mixing injection amount and the pre-mixing fuel injection amount of the previous combust sequence cylinder, and the controller may control the operation of the injector depending on the correction factor and the pre-mixing fuel injection amount of the previous combust sequence cylinder.

The controller may determine the correction factor and the pre-mixing fuel injection amount of the previous combust sequence cylinder by a feedback.

The controller may determine a starting timing of the pre-mixing injection depending on a timing that an air of the cylinder is flowed backward to the intake manifold, a time that the fuel is vaporized in the cylinder, and an injection period of the pre-mixing fuel to control the operation of the injector.

The controller may determine a finishing timing of the pre-mixing injection before a closing time of the intake valve to control the operation of the injector.

According to the pre-mixing engine system and the control method for the same according to an exemplary embodiment of the present invention, as the homogenous mixture is formed, a maximum temperature of the combust period is lowered, reducing the nitrogen oxide and the soot generation.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of a pre-mixing engine system according to an exemplary embodiment of the present invention.

FIG. 2 is a schematic diagram of a pre-mixing engine system according to an exemplary embodiment of the present invention.

FIG. 3 is a view to explain an operation of a pre-mixing engine system according to an exemplary embodiment of the present invention.

FIG. 4 is a flowchart of a control method of a pre-mixing engine system according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In the following detailed description, only certain exemplary embodiments of the present invention have been shown and described, simply by way of illustration.

As those skilled in the art would realize, the described embodiments may be modified in various different ways, all without departing from the spirit or scope of the present invention

Throughout the specification, components denoted by the same reference numerals are the same components.

In addition, unless explicitly described to the contrary, the word “comprise” and variations such as “comprises” or “comprising”, will be understood to imply the inclusion of stated elements but not the exclusion of any other elements.

An exemplary embodiment of the present invention will hereinafter be described in detail with reference to the accompanying drawings.

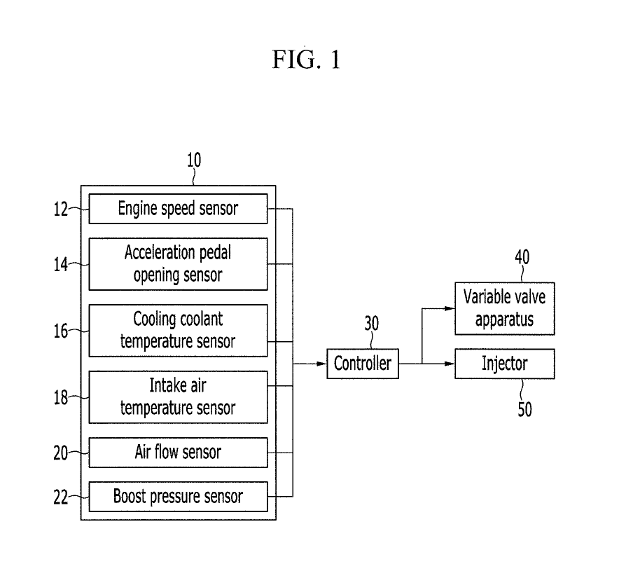

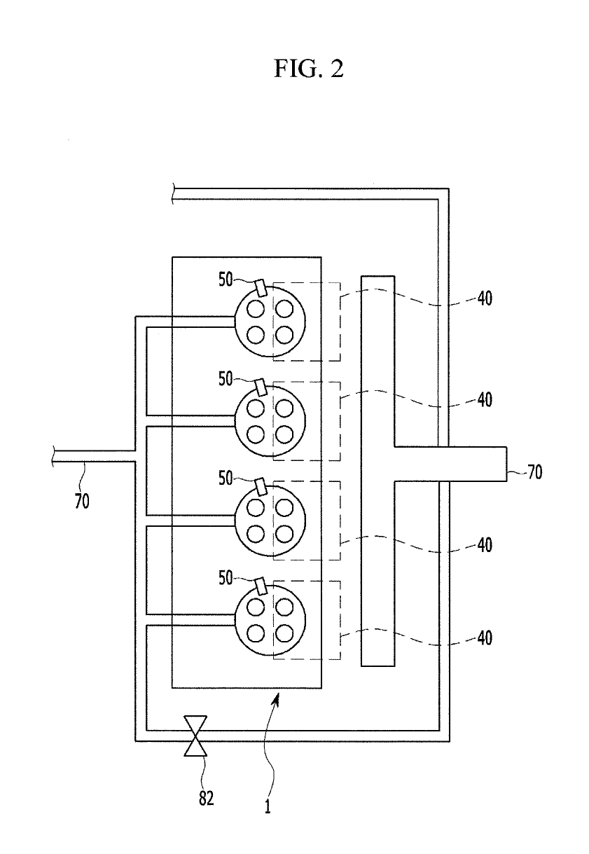

FIG. 1 is a block diagram of a pre-mixing engine system according to an exemplary embodiment of the present invention, and FIG. 2 is a schematic diagram of a pre-mixing engine system according to an exemplary embodiment of the present invention.

Referring to FIG. 1 and FIG. 2, a pre-mixing engine system according to an exemplary embodiment of the present invention includes a plurality of cylinders #1, #2, #3, and #4 that are combusted with a predetermined sequence, an intake manifold 70 connected to the cylinders #1, #2, #3, and #4, a variable valve apparatus 40 controlling an intake valve closing timing of each of the cylinders #1, #2, #3, and #4, an injector 50 injecting the fuel inside each of the cylinders #1, #2, #3, and #4, an operation state measuring device 10 detecting an operation state of an engine to output a corresponding signal, and a controller 30 controlling an operation of the injector 50 and the variable valve apparatus 40 depending on the corresponding signal of the operation state measuring device 10.

The controller 30 determines whether an operation state of a current engine is a predetermined general operation mode requirement state or a predetermined pre-mixing mode requirement state and controls the operations of the variable valve apparatus 40 and the injector 50 in the case of the pre-mixing mode requirement state to flow backward a mixture of the corresponding cylinders #1, #2, #3, and #4 to the intake manifold 70.

The variable valve apparatus 40 as a variable apparatus of various types controlling a closing timing of the intake valve depending on the control signal of the controller 30, for example, may be an apparatus of various type including a variable valve lift apparatus (VVL), a continuous variable valve lift apparatus (CVVL), a variable valve timing apparatus (VVT), a continuous variable valve timing apparatus (CVVT), a variable duration apparatus (VVD), a continuous variable valve duration apparatus (CVVD), etc.

The operation state measuring device 10 may include an engine speed detector 12, an acceleration pedal opening detector 14, a cooling coolant temperature detector 16, an intake air temperature detector 18, an air flow detector 20, and a boost pressure detector 22.

The general operation mode means an operation state of a conventional engine of which an output is required or a pre-mixing is not required.

The pre-mixing mode as a driving state configured for reducing a nitrogen oxide (NOx) and a soot generation by forming a homogenous mixture of the engine to lower the maximum temperature of the combust period may be defined by a case that an engine speed is less than a predetermined speed, an operation load of the engine is less than a predetermined value, an intake air temperature is a predetermined value or more, for example, 20 degrees, and a cooling water temperature is a predetermined value or more, for example, 60 degrees.

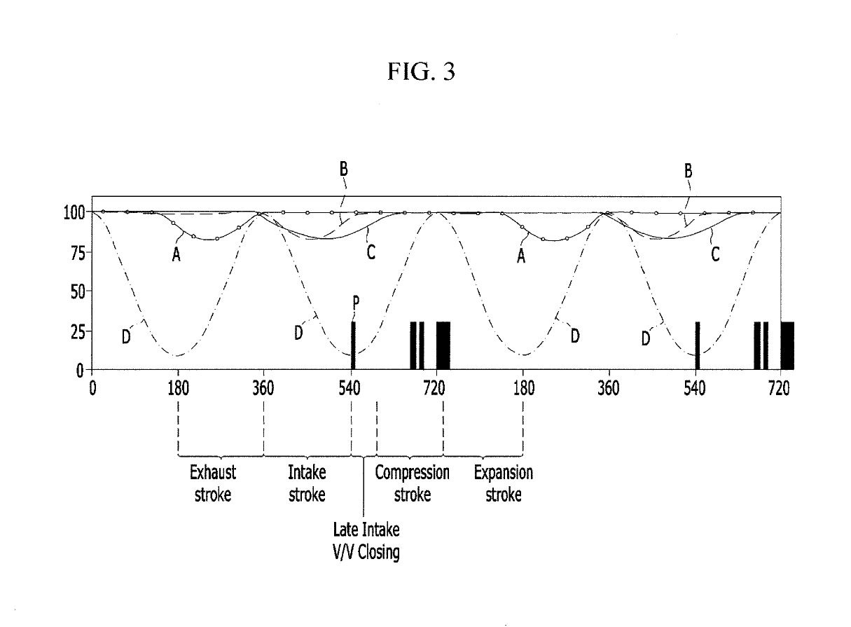

FIG. 3 is a view to explain an operation of a pre-mixing engine system according to an exemplary embodiment of the present invention.

Referring to FIG. 1 to FIG. 3, the controller 30 controls the operation of the variable valve apparatus 40 to delay the intake valve closing timing and controls the operation of the injector 50 to execute a pre-mixing injection of the fuel to be flowed backward thereof.

“A” of FIG. 3 represents a profile of the exhaust valve, “B” represents a profile of the intake valve of the general operation mode, “C” represents an profile of the intake valve of the pre-mixing mode, and “D” represents a position of a piston.

In the drawing, the pre-mixing engine system according to an exemplary embodiment of the present invention is applied to a four-cylinder engine, but is not limited thereto. However, for convenience of an understanding, an example that the present invention is applied to the four-cylinder engine will be described. It is assumed that the four-cylinder engine has a combust sequence determined with a #1, #3, #4, #2 cylinder sequence.

In the general operation mode, the intake valve is closed near a bottom dead center, and the injection of the fuel is performed after the intake valve is closed. The fuel injection after the intake valve is closed is referred to as a main injection (M).

The controller 30 determines whether operation mode is the general operation mode requirement state or the predetermined pre-mixing mode requirement state depending on an output signal of the operation state measuring device 10, when the controller 30 determines that the operation mode currently required is the predetermined pre-mixing mode, the controller 30 controls the operation of the variable valve apparatus 40 to delay the intake valve closing timing (referring to “C” of FIG. 3 and controls the operation of the injector 50 to execute the pre-mixing injection (referring to “P” of FIG. 3).

For example, in a state that the intake valve of the first cylinder #1 is opened, the pre-mixing injection P is executed before the main injection M, and then the intake valve is closed between the bottom dead center and the top dead center.

The fuel injected during the pre-mixing injection P flows backward to the intake manifold 70 along with an air inside the cylinder by the operation of the piston and is supplied to the third cylinder #3 along with a fresh air as a following combust sequence.

The fuel of the pre-mixing injection P in the first cylinder #1 becomes the homogenous mixture through the backflow process and the inflow process from the intake manifold 70 to the third cylinder #3. Next, the fuel of the pre-mixing injection P that partially flows backward in the third cylinder #3 is supplied to the fourth cylinder #4 in the mixture state through the intake manifold 70.

The pre-mixture supplied to the third cylinder #3 is combusted with the fuel of the main injection M of the third cylinder #3 and the mixture that is relatively homogenous is formed, reducing the nitrogen oxide (NOx) and the soot generation.

The above-described combust process is repeated through each cylinder.

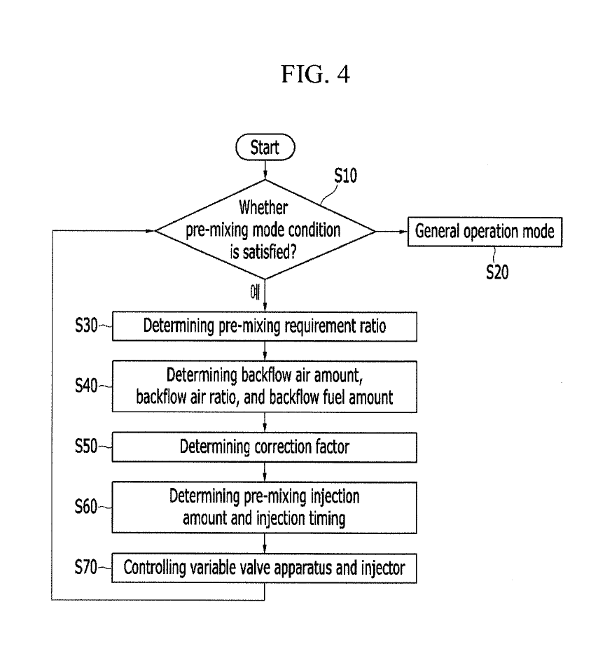

FIG. 4 is a flowchart of a control method of a pre-mixing engine system according to an exemplary embodiment of the present invention.

Next, a control method of the pre-mixing engine system according to an exemplary embodiment of the present invention will be described with reference to FIG. 1, FIG. 2, FIG. 3, and FIG. 4.

The controller 30 determines whether the operation state of the current engine is the predetermined general operation mode requirement state or the predetermined pre-mixing mode requirement state depending on the output signal of the operation state measuring device 10 (S10).

When the operation state of the current engine is the general operation mode requirement state, the controller 30 controls the operations of the injector 50 and the variable valve apparatus 40 depending on the predetermined general operation mode (S20).

When the operation state of the current engine is the pre-mixing mode requirement state, the controller 30 determines a pre-mixing fuel amount ratio (S30) and an air amount to be flowed backward (S40), and determines a valve timing depending on the determined backflow air amount (S60) to control the operation of the variable valve apparatus and to control the operation of the injector depending on the determined pre-mixing fuel amount ratio (S70).

The controller 30 may determine the entire injection fuel amount, the pre-mixing fuel amount requirement value, and the pre-mixing fuel amount requirement ratio depending on the signal of the operation state measuring device 10 and may control the operation of the injector depending on the determined pre-mixing fuel amount requirement value in a beginning of the pre-mixing mode switching.

That is, the pre-mixing mode entry beginning, for example, when the pre-mixing mode enters from the first cylinder #1, the pre-mixing fuel amount requirement ratio is determined by a function including the engine speed, the acceleration pedal opening, the coolant temperature, or is obtained from a map that is experimentally predetermined.

Ratio_hFuel_des_init=f(speed, accel, ETS . . . )

A Ratio_hFuel_des_init represents a pre-mixing fuel amount requirement ratio of the pre-mixing mode entry beginning, and a speed, an accel, and an ETS respectively represents an engine speed, an acceleration pedal opening, and a coolant temperature.

The entire injection fuel amount is determined through the vehicle speed and the acceleration pedal opening or is obtained from a predetermined map through an experiment.

The pre-mixing fuel amount requirement value is obtained through the entire injection fuel amount and the pre-mixing fuel amount requirement ratio.

Mfuel_h_des=MFuel_total×Ratio_hFuel_des_init

(the pre-mixing fuel amount requirement value=an entire fuel injection amount*the pre-mixing fuel amount requirement ratio of the pre-mixing mode entry beginning)

There is not the injection an additional fuel at the pre-mixing mode entry beginning such that the pre-mixing fuel amount requirement value becomes the pre-mixing injection amount.

Mfuel_h_Inj_init=Mfuel_h_des

(the pre-mixing fuel injection amount initial value=the pre-mixing fuel amount requirement value)

The controller 30, after the pre-mixing mode conversion beginning, for example in the case of the third cylinder #3, determines a backflow air amount, a backflow air ratio, and a backflow fuel amount according to the signal of the operation state measuring device 10, the pre-mixing fuel amount requirement ratio and the pre-mixing fuel injection amount of the previous combust sequence cylinder, for example the first cylinder #1 (S40).

The backflow air amount device the air amount flowed backward to the intake manifold, the backflow air ratio means a ratio of the backflow air amount to air amount inside the cylinder and the backflow fuel amount means the fuel amount flowed backward to the intake manifold. In the instant case, the backflow air amount, the backflow air ratio, and the backflow fuel amount may be obtained from a map that is experimentally predetermined.

Also, the controller 30 determines a reference mixing injection amount according to the backflow air amount, the backflow air ratio, and the backflow fuel amount, determines a correction factor according to the determined reference mixing injection amount and the pre-mixing fuel injection amount of the previous combust sequence cylinders #1, #2, #3, and #4 (S50), and the controller may control the operations of the variable valve apparatus 40 and the injector 50 depending on a sum of the correction factor and the pre-mixing fuel injection amount of the previous combust sequence cylinder #1, #2, #3, and #4.

After the pre-mixing mode conversion beginning, for example in the case of the third cylinder #3, the pre-mixing mode fuel ratio requirement value is determined by the engine speed, the acceleration pedal opening, the coolant temperature, etc. or is obtained from the predetermined map through the experiment.

Ratio_hFuel_des=f(speed, accel, ETS . . . )

The pre-mixing fuel requirement value may be determined as follows.

Mfuel_h_des=Mfuel total×Ratio_hFuel_des

(the pre-mixing fuel requirement value=the entire fuel injection amount*the pre-mixing mode fuel ratio requirement value)

For example, the backflow amount of the third cylinder #3 is determined into a function of the pre-mixing mode fuel amount requirement ratio, the engine speed, the acceleration pedal opening, etc, or is obtained from the predetermined map by the experiment.

Mair_out=f(Ratio_hFuel_des, speed, accel . . . )

(the air amount flowed backward to the intake manifold=f(the pre-mixing mode fuel amount requirement ratio, the engine speed, the acceleration pedal opening . . . )

A closing timing delay ratio (an LIVC control ratio) of the variable valve apparatus 40 is determined as followings.

fac_LIVC=Mair_out/Mair_cylinder

(the LIVC control ratio=the air amount flowed backward to the intake manifold/the air amount inside the cylinder)

The backflow mixture is determined as following.

fac_LIVC×(Mair_cylinder+Mfuel_h_inj_old)=Mmix_out

(LIVC control ratio*(the air amount inside the cylinder+the directly previous pre-mixing fuel injection amount)=the fuel and the air amount flowed backward to the intake manifold)

In the instant case, the directly previous pre-mixing fuel injection amount is the pre-mixing fuel injection amount of the first cylinder #1, for example.

The mixture in the cylinder is determined as followings.

Mmix_out+Mair_HFM=Mmix_cylinder

(the mixture (the fuel+the air amount) flowed backward to the intake manifold+the air amount measured by the HFM (the air flow sensor; 20)=the mixture amount in the cylinder)

The determined reference mixing injection amount may be determined by the closing timing delay ratio (fac_LIVC), the previous pre-mixing fuel injection amount (Mfuel_h_inj_old), etc.

(1-fac_LIVC)×(Mfuel_h_inj_old×fac_LIVC+Mfuel_h_inj_old)=Mfuel_h_std

(1-fac_LIVĈ2)×Mfuel_h_inj_old=Mfuel_h_std

The engine speed, the acceleration pedal opening, the pre-mixing mode fuel ratio requirement value (Mfuel_h_des) obtained by the coolant temperature, the closing timing delay ratio, and the reference mixing injection amount (Mfuel_h_std) determined by the previous fuel injection amount are compared to determine the correction factor(Δ) (S50).

Mfuel_h_des−Δ=Mfuel_h_std

Also, the correction factor (Δ) is added to the previous pre-mixing fuel injection amount Mfuel_h_inj_old to obtain the actual pre-mixing fuel injection amount Mfuel_h_inj.

Mfuel_h_inj_old+Δ=Mfuel_h_inj,

The controller 30 may determine the correction factor (Δ) and the pre-mixing fuel injection amount Mfuel_h_inj_old of the previous combust sequence cylinder through a feedback control.

For example, a weight value of the correction factor (Δ) may be adjusted by comparing a change amount of the pre-mixing fuel injection amount Mfuel_h_inj_old of the previous combust sequence cylinder.

The controller may control the operation of the injector by determining a starting timing of the pre-mixing injection depending on the timing that the air in the cylinders #1, #2, #3, and #4 is flowed backward to the intake manifold, a time that the fuel is vaporized in the cylinders #1, #2, #3, and #4, and the injection period of the pre-mixing fuel.

Angle_inverse−Duration_evap−Duration_Inj=Angle_SOI

(the backflow starting timing of the air to the intake port in the cylinder−the time that the fuel is vaporized in the cylinder−the injection period of the pre-mixing fuel=the injection starting time)

The pre-mixing fuel injection timing may be obtained by the time that the injection of the pre-mixing fuel is finished and the pre-mixing fuel is vaporized such that the injection timing is determined by the above-described equation.

The controller 30 may determinate a finishing timing of the pre-mixing injection before the intake valve closing time to control the operation of the injector 50.

That is, the pre-mixing injection must be finished before at least intake valve is closed, the pre-mixing injection fuel may be flowed backward to the intake manifold 70.

As described above, according to the pre-mixing engine system and the control method according to an exemplary embodiment of the present invention, as the homogenous mixture is formed, the maximum temperature of the combust period is lowered, reducing the nitrogen oxide and the soot generation.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A pre-mixing engine system comprising:
a plurality of cylinders that are combusted in a predetermined sequence;
an intake manifold connected to the cylinders;
a variable valve apparatus controlling an intake valve closing timing of each cylinder;
an injector injecting a fuel inside each cylinder;
an operation state measuring device detecting an operation state of an engine to output a corresponding signal; and
a controller configured for controlling operations of the injector and the variable valve apparatus depending on the corresponding signal of the operation state measuring device,
wherein the controller is configured to determine whether the operation state of a current engine is a predetermined general operation mode requirement state or a predetermined pre-mixing mode requirement state and is configured to control the operations of the variable valve apparatus and the injector in a case of the pre-mixing mode requirement state to output a mixture of the corresponding cylinder to the intake manifold.

2. The pre-mixing engine system of claim 1, wherein
the controller is configured to control the operation of the variable valve apparatus to delay the intake valve closing timing and is configured to control the operation of the injector to perform a pre-mixing injection injecting a fuel to be flowed backward thereof.

3. The pre-mixing engine system of claim 2, wherein
the operation state measuring device includes an engine speed sensor, an acceleration pedal opening sensor, a cooling coolant temperature sensor, an intake air temperature sensor, an air flow sensor, and a boost pressure sensor.

4. The pre-mixing engine system of claim 3, wherein
the controller is configured to determine a pre-mixing fuel amount ratio in a case of the pre-mixing mode requirement state,
is configured to determine an air amount to be flowed backward to determine a valve timing depending on the determined backflow air amount, controlling the operation of the variable valve apparatus, and
is configured to control the operation of the injector depending on the determined pre-mixing fuel amount ratio.

5. The pre-mixing engine system of claim 3, wherein
the controller is configured to determine an entire injection fuel amount, a pre-mixing fuel amount requirement value, and a pre-mixing fuel amount requirement ratio depending on the signal of the operation state measuring device, and
is configured to control the operation of the injector depending on the determined pre-mixing fuel amount requirement value at a pre-mixing mode conversion beginning

6. The pre-mixing engine system of claim 5, wherein
the controller is configured to determine a backflow air amount, a backflow air ratio, and a backflow fuel amount depending on the signal of the operation state measuring device, the pre-mixing fuel amount requirement ratio, and a pre-mixing fuel injection amount of a previous combust sequence cylinder after the pre-mixing mode conversion beginning,
the controller is configured to determine a reference mixing injection amount depending on the backflow air amount, the backflow air ratio, and the backflow fuel amount, and
the controller is configured to determine a correction factor depending on the determined reference mixing injection amount and the pre-mixing fuel injection amount of the previous combust sequence cylinder, and
the controller is configured to control the operations of the variable valve apparatus and the injector depending on a sum of the correction factor and the pre-mixing fuel injection amount of the previous combust sequence cylinder.

7. The pre-mixing engine system of claim 6, wherein
the controller is configured to determine the correction factor and the pre-mixing fuel injection amount of the previous combust sequence cylinder through a feedback control.

8. The pre-mixing engine system of claim 2, wherein
the controller is configured to determine a starting timing of the pre-mixing injection depending on a timing that an air in the each cylinder is flowed backward to the intake manifold, a time that the fuel is vaporized in the each cylinder, and an injection period of the pre-mixing fuel to control the operation of the injector.

9. The pre-mixing engine system of claim 8, wherein
the controller is configured to determine a finishing timing of the pre-mixing injection before a closing time of the intake valve to control the operation of the injector.

10. A control method of a pre-mixing engine system including a plurality of cylinders that are combusted in a predetermined sequence; an intake manifold connected to the cylinder; a variable valve apparatus controlling an intake valve closing timing of each cylinder; an injector injecting a fuel to an inside of each cylinder; an operation state measuring device detecting an operation state of an engine to output a corresponding signal; and a controller configured for controlling operations of the injector and the variable valve apparatus depending on a corresponding signal of the operation state measuring device, including;
determining whether an operation state of a current engine is a predetermined general operation mode requirement state or a predetermined pre-mixing mode requirement state through the controller;
determining a pre-mixing fuel amount ratio in a case of the pre-mixing mode requirement state through the controller;
determining an air amount to be flowed backward and a valve timing depending on the determined backflow air amount to control the operation of the variable valve apparatus through the controller; and
controlling the operation of the injector depending on the determined pre-mixing fuel amount ratio through the controller.

11. The control method of claim 10, wherein
the controller is configured to determine an entire injection fuel amount, a pre-mixing fuel amount requirement value, and a pre-mixing fuel amount requirement ratio depending on a signal of the operation state measuring device, and
the controller is configured to control the operation of the injector depending on the determined pre-mixing fuel amount requirement value at a pre-mixing mode conversion beginning.

12. The control method of claim 11, wherein
the controller is configured to determine a backflow air amount, a backflow air ratio, and a backflow fuel amount depending on the signal of the operation state measuring device, a pre-mixing fuel amount requirement ratio, and a pre-mixing fuel injection amount of a previous combust sequence cylinder after the pre-mixing mode conversion beginning,
the controller is configured to determine a reference mixing injection amount depending on the backflow air amount, the backflow air ratio, and the backflow fuel amount,
the controller is configured to determine a correction factor depending on the determined mixing injection amount and the pre-mixing fuel injection amount of a previous combust sequence cylinder, and
the controller is configured to control the operation of the injector depending on the correction factor and the pre-mixing fuel injection amount of the previous combust sequence cylinder.

13. The control method of claim 12, wherein
the controller is configured to determine the correction factor and the pre-mixing fuel injection amount of the previous combust sequence cylinder by a feedback control.

14. The control method of claim 10, wherein
the controller is configured to determine a starting timing of the pre-mixing injection depending on a timing that an air of the each cylinder is flowed backward to the intake manifold, a time that the fuel is vaporized in the each cylinder, and an injection period of the pre-mixing fuel to control the operation of the injector.

15. The control method of claim 14, wherein
the controller is configured to determine a finishing timing of the pre-mixing injection before a closing time of the intake valve to control the operation of the injector.
